(19) United States
(12) Patent Application Publication
(10) Pub. No.: US 2007/0283192 A1
(43) Pub. Date: Dec. 6, 2007

(54) Automated threat analysis

(76) Inventor: Sergei Shevchenko, New South Wales (AU)

Correspondence Address: Eric D. Cohen, 22nd Floor, 120 South Riverside Plaza, Chicago, IL, 60606-3945, US

(21) Appl. No.: 11/600,259

(22) Filed: Nov. 15, 2006

(30) Foreign Application Priority Data
Feb. 8, 2006 (AU) 2006-100099

(51) Int. Cl. G06F 11/00

(52) U.S. Cl. 714/39

(57) ABSTRACT

An automated threat analysis system comprising a core in an isolated environment, the core associated with an input interface and an output interface. The core comprises one or more core components and an operating system having at least one library hooked to at least one of the one or more core components. In use, a threat (eg. malicious software) is passed into the core via the input interface and the threat is executed in the core using the operating system. Report data is generated by the one or more core components which monitors the functions/processes occurring in the system as a result of the threat, and the report data is passed out of the core via the output interface according to a predefined format so as to isolate any output from or escape of the threat.

### TECHNICAL FIELD

The present invention generally relates to the field of computing and malicious software or software threats, such as for example a computer virus, and more particularly to a method, system, computer readable medium of instructions and/or computer program product for providing automated threat analysis.

### BACKGROUND ART

As used herein a “threat” includes malicious software, also known as “malware” or “pestware”, which includes software that is included or inserted in a part of a processing system for a harmful purpose. Types of malware can include, but are not limited to, malicious libraries, viruses, worms, Trojans, adware, malicious active content and denial of service attacks. In the case of invasion of privacy for the purposes of fraud or theft of identity, malicious software that passively observes the use of a computer is known as “spyware”.

A hook (also known as a hook procedure or hook function), as used herein, generally refers to a callback function provided by a software application that receives certain data before the normal or intended recipient of the data. A hook function can thus examine or modify certain data before passing on the data. Therefore, a hook function allows a software application to examine data before the data is passed to the intended recipient.

An API (“Application Programming Interface”) hook (also known as an API interception), as used herein as a type of hook, refers to a callback function provided by an application that replaces functionality provided by an operating system's API. An API generally refers to an interface that is defined in terms of a set of functions and procedures, and enables a program to gain access to facilities within an application. An API hook can be inserted between an API call and an API procedure to examine or modify function parameters before passing parameters on to an actual or intended function. An API hook may also choose not to pass on certain types of requests to an actual or intended function.

A process, as used herein, is at least one of a running software program or other computing operation, or a part of a running software program or other computing operation, that performs a task.

A hook chain as used herein, is a list of pointers to special, application-defined callback functions called hook procedures. When a message occurs that is associated with a particular type of hook, the operating system passes the message to each hook procedure referenced in the hook chain, one after the other. The action of a hook procedure can depend on the type of hook involved. For example, the hook procedures for some types of hooks can only monitor messages, others can modify messages or stop their progress through the chain, restricting them from reaching the next hook procedure or a destination window.

A kernel, as used herein, refers to the core part of an operating system, responsible for resource allocation, low-level hardware interfaces, security, etc.

An interrupt, as used herein, is at least one of a signal to a processing system that stops the execution of a running program so that another action can be performed, or a circuit that conveys a signal stopping the execution of a running program.

A library is a file containing executable code and data which can be loaded by a process at load time or run time, rather than during linking. There are several forms of a library including, but not limited to, Dynamic Linked Libraries (DLL) and Active X technologies.

In a networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may include or be associated with other devices, for example a local data storage device such as a hard disk drive or solid state drive.

An information source can include a server, or any type of terminal, that may be associated with one or more storage devices that are able to store information or data, for example in one or more databases residing on a storage device. The exchange of information (ie. the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

A system registry is a database used by modern operating systems, for example Windows™ platforms. The system registry includes information needed to configure the operating system. The operating system refers to the registry for information ranging from user profiles, to which applications are installed on the machine, to what hardware is installed and which ports are registered.

Manual Threat Analysis

Known techniques that seek to protect users against unwanted threats or malicious software rely on anti-virus (“AV”) software that firstly attempt to identify a threat. Once the threat is identified the threat is then blocked from affecting the user environment, for example the threat is disinfected, deleted or quarantined. This process normally requires the following steps:
1. A threat, being an unknown file, is scanned by an AV product;
2. Based on the results of the scan the unknown file is either allowed or blocked in some manner;
3. A false negative is a common and problematic issue. A false negative occurs each time a threat is wrongly identified by an AV product as being a clean file or as not being identified as malicious. New threats are typically designed with the purpose of avoiding detection by an AV product, that is to achieve a false negative result, in order to compromise a user environment (eg. a user processing system);
4. Whenever a new threat penetrates past an AV product into a user environment, typically only a relatively short period of time elapses until the threat is known to AV product vendors via various threat submission mechanisms. Some AV detection products may identify a threat based on behavioural patterns. Once a threat is intercepted or identified, the threat is initially considered “suspicious” and is still required to be submitted to an AV product vendor for the following purposes:
   (a) The suspicious or potential threat needs to be identified;
   (b) If the potential threat is confirmed as a threat by analysts then new threat detection mechanisms must be created based on signatures or threat detection algorithms;
   (c) AV software products must be updated with the new threat detection mechanisms; and
   (d) The new threat should be described to define and enable threat removal procedures, threat characteristics, replication mechanisms, etc.

This is the typical process that is presently followed to identify threats and update AV products. Even when AV products rely on identifying potential threats by suspicious behaviour, such suspicious behaviour-based AV products are generally considered to be prone to false positives. Thus, the known manual approach remains the most effective solution, whereby a potential threat is submitted to and analysed by a human analyst, prior to updating AV software products and producing documentation describing removal procedures, threat characteristics, replication mechanisms, etc.

This known process is illustrated in FIG. 1. In process 10 a threat 12 emerges from the Internet 14. If threat 12 is not identified by AV product 16 a user 18 may become aware of threat 12 and inform AV vendor 20 of suspicious activity of threat 12. AV vendor 20 analyses threat 12 and may be required to update AV product 16 so that the next time AV product 16 encounters threat 12 the threat is identified and banned or blocked at step 22.

In practice a new threat is normally discovered relatively quickly, for example by being intercepted by proactive detection system or a suspicious file being submitted by a cautious user. The main “bottle-neck” of the presently known process is the AV product vendor response time. During the period of time an AV product vendor is identifying a threat, a user environment remains vulnerable to that threat because virus dictionaries have not as yet been updated.

The threat identification phase is the most important and critical stage. The major reason why it normally takes at least hours for an AV product vendor to respond is because the threat identification phase involves extensive manual analysis performed by specialist malicious software analysts. Once a threat is identified, for example as a spybot, a new virus dictionary update can be created and delivered to AV software product installations and a user environment is then secured against the threat.

However, once a new threat is identified it is still required to be described. Users/customers may now have a new set of concerns, for example: where did the threat come from (eg. country of origin)? Is the threat based on other threats in its functionality (eg. are there any similarities with other threats)? What sort of exploits/vulnerabilities does the threat employ? What are the side effects or what was the actual damage caused? How to revert a system into a pre-infection stage (eg. removal instructions)? What sort of confidential information may have been stolen? What sort of reputation damage may have been caused? How vulnerable is a system for future threats similar to the identified threat? and many other concerns.

Preferably, any threat mitigation task is associated with not only threat identification, but also the important task of threat description. Some AV product vendors follow a practice of providing generic detections, for example when a single virus name represents thousands of virus variations. In practice, this means that a user/customer receives a virus dictionary update to detect a new threat with no clarification regarding the threat functionality, removal instructions, and many other threat mitigation issues.

Thus, two manual activities involve “threat identification” and “threat description” and require an extensive manual analysis, and therefore provide the largest contribution to delays in overall response time in updating AV products. Both threat identification and threat description can be considered as a single concept, that of“threat analysis”.

Threat analysts around the world employ various techniques in threat analysis. However, presently threat analysis is essentially a manual process and typically involves the following manual actions:
1. A threat is unpacked/decoded/unencrypted to obtain a form that is as close to the original threat form as possible: by applying stand-alone tools; by emulating threat code until some portions of data are unpacked/decoded/unencrypted; or by “black-boxing” a threat in an isolated environment so that the process module of the threat can be dumped for further study;
2. The original form is then reviewed to visually detect any suspicious or common strings. This may also give an experienced analyst an indication of what known threats may be similar, what the threat “looks like”, does the threat remind the analyst of any existing threat families or not. An experienced analyst may have already identified a threat at this stage, for example the analyst may conclude “this threat is a new IRC bot” or similar.
3. If a threat is still not identified and/or a threat needs to be studied in more detail, an analyst carries out two types of analysis being “white-boxing” and “black-boxing”. White-boxing analysis involves threat disassembly in order to study the assembler code of the threat and identify the threat's functionality on the lowest possible level. Black-boxing involves implanting a threat into an isolated environment where the threat is executed with no risk of infecting other systems.
4. Black-boxing analysis provides an analyst with information on what a threat is actually doing in a system, while white-boxing reveals what a threat may potentially do. Black-boxing is normally carried out either in the real physical environment or inside a hardware-emulated virtual environment. As a threat is expected to run unnoticed to convince a user that nothing unusual is happening in the user environment, an analyst employs software products to reveal any stealth-mode functionality and/or any system changes, such as a malicious payload or other less destructive side-effects. Such software products include file/registry monitors, root kit revealers, file system/registry snap shot providers or network traffic sniffers.

There exists a need for a method, system, computer readable medium of instructions, and/or a computer program product to provide automated threat analysis which addresses or at least ameliorates one or more problems inherent in the prior art.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### DISCLOSURE OF INVENTION

According to a first broad form, there is provided an automated threat analysis system comprising a core, the core associated with an input interface and an output interface and the core comprising: one or more core components; and, an operating system having at least one library hooked to at least one of the one or more core components; wherein, when a threat is passed into the core and the threat is executed in the core, report data is generated and the report data is passed out of the core via the output interface.

According to a second broad form, there is provided a computer program product for providing automated threat analysis, the computer program product comprising a core, the core associated with an input interface and an output interface and the core comprising: one or more core components; and, an operating system having at least one library hooked to at least one of the one or more core components; wherein, the computer program product is configured such that when a threat is passed into the core and the threat is executed in the core, report data is generated and the report data is passed out of the core via the output interface.

According to a third broad form, there is provided a method of providing automated threat analysis by utilising a core, the core associated with an input interface and an output interface, the core comprising one or more core components and an operating system having at least one library hooked to at least one of the one or more core components, the method comprising the steps of, in a processing system: passing a threat into the core; executing the threat in the core; generating report data using the one or more core components; and, passing the report data out of the core via the output interface.

According to a particular embodiment, an Automated Threat Analysis System (ATAS) is provided and is designed to accelerate threat identification and threat description phases for new threats, real or potential, thereby providing a significant reduction in time for the entire threat analysis response cycle. This assists an AV product vendor to respond accurately and in a timely manner to new threats. ATAS, in one form, can provide answers to questions that users/customers or AV product vendors may have regarding threat functionality, such as a description of threat characteristics, removal instructions and/or replication mechanisms.

In another form, as ATAS is automated, the system may automatically build descriptions for various threats. These descriptions can be used to update a comprehensive forensics database with search capabilities, such as the ability to search possible side effects for all known threats. If a new threat reveals a certain set of side effects then a search for those features in the database may assist in identifying a threat family to which the new threat belongs, and therefore reveal any additional features/characteristics the new threat may have. This can help security agencies to obtain more information about specific threats and not only those threats that are published by AV product vendors.

According to another embodiment, this allows ATAS to be used to automatically build a threat removal tool by knowing the scope of side effects caused by a threat. In another non-limiting form, the report data is passed out of the core via the output interface according to a predefined format.

According to other forms, the present invention provides a computer readable medium of instructions or a computer program product for giving effect to any of the methods or systems mentioned herein. In one particular, but non-limiting, form, the computer readable medium of instructions are embodied as a software program.

### BRIEF DESCRIPTION OF FIGURES

An example embodiment of the present invention should become apparent from the following description, which is given by way of example only, of a preferred but non-limiting embodiment, described in connection with the accompanying figures.

FIG. 1 illustrates a known manual method of analysing threats;

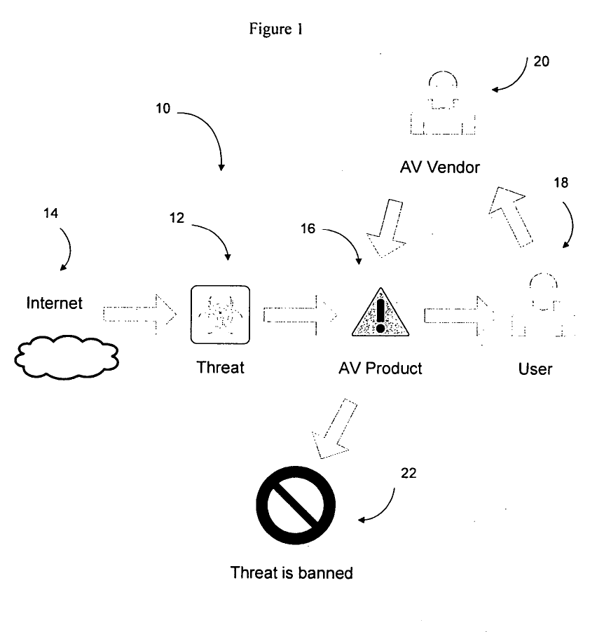

FIG. 2 illustrates a functional block diagram of an example processing system that can be utilised to embody or give effect to a particular embodiment;

FIG. 3 illustrates a functional block diagram of an example automated threat analysis system;

FIG. 4 illustrates a flow diagram of an example method for automated threat analysis; and,

FIG. 5 illustrates a functional block diagram of a further example automated threat analysis system.

### MODES FOR CARRYING OUT THE INVENTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

Processing System

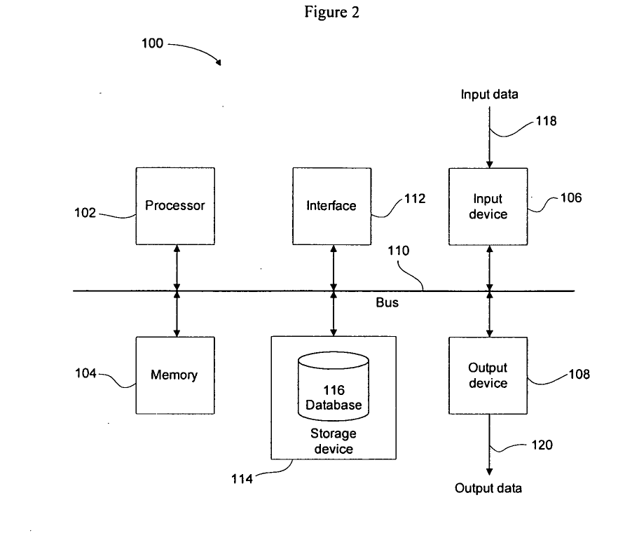

A particular embodiment of the present invention can be realised using a processing system, an example of which is shown in FIG. 2. In particular, processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, processing system 100 is adapted to allow data or information to be stored in and/or retrieved from, via wired or wireless communication means, the at least one database 116, and also for processes or software modules to be executed. The interface 112 may allow wired and/or wireless communication between processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

Processing system 100 may be an isolated system when analysing a threat. However, if appropriate, processing system 100 may be a part of a networked communications system. Processing system 100 could connect to network, for example the Internet or a WAN. Input data 118 and/or output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Automated Threat Analysis System

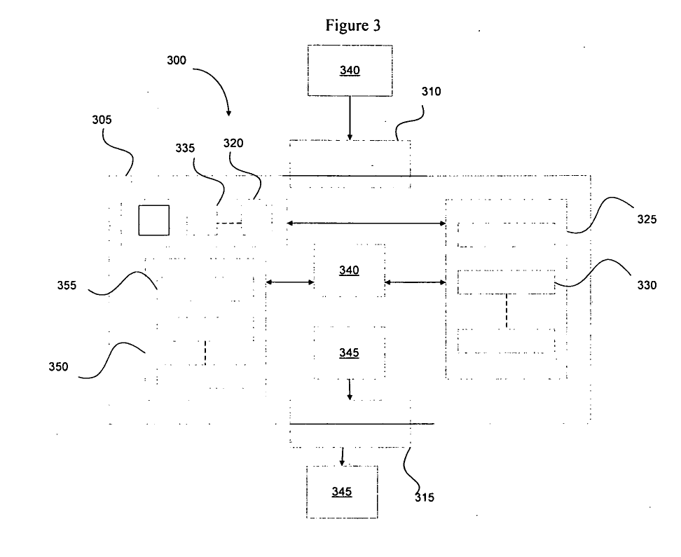

Referring to FIG. 3, there is illustrated an automated threat analysis system 300 comprising a core 305 in an isolated environment, core 305 is associated with an input interface 310 and an output interface 315. Core 305 includes one or more core components 320 and an operating system 325 where at least one library 330 of operating system 325 is hooked to at least one core component 335 of the one or more core components 320.

When a threat 340 is passed into core 305 via input interface 310 and threat 340 is executed in core 305 using operating system 325 this results in report data 345 being generated by the one or more core components 320. Report data 345 is then passed out of core 305 via output interface 315, which in one non-limiting example may be according to a predefined format. For example, a predefined format of report data 345 can be used to further isolate threat 340 so that threat 340 cannot escape or send output data from core 305 thereby maintaining core 305 as an isolated environment.

A predefined format of report data 345 is not essential as if a threat attempts to escape core 305 by infecting report data 345 that core 305 delivers back into the clean environment, then the format of the data will eventually be violated because threat 340 is not aware of that format. Data with a corrupted format would simply be discarded and analysis of such a threat can be considered as failed.

System 300 can also be provided with a snapshot manager to record the state of at least part of core 305 before and after execution of threat 340. At least some of any differences in the state of core 305, for example in the state of operating system 325, before execution of threat 340 and after execution of threat 340 can form part of report data 345. The snapshot manager can also include or be associated with a database of exclusions of known differences in state before and after execution to filter out normal changes caused by normal operation of operating system 325.

Furthermore, system 300 can include at least one or more service components 350 and each particular service component 355 can be used to monitor at least one port associated with operating system 325. A service component 355 can also emulate response data at a port using a particular protocol. One or more core components 320 can be used to record at least part of any data transferred via a port using a protocol. Such recorded data can then form part of report data 345.

System 300 can be associated with a searchable database to store report data 345 from various threats. Operating system 325 may be a modified Windows® operating system. Preferably, operating system 325 functions and parameters used by threat 340 are logged by the one or more core components 320. It is also possible that at least some return data from operating system 325 functions is modified by the one or more core components 320.

A core manager can also be provided which at least in part supplies threat 340 to core 305 and receives report data 345 from core 305. System 300 may also include a wrapper acting as an interface between the core manager and the searchable database. The core manager can also be used to control return data on ports to core 305 that may be used by threat 340. The return data to ports can be provided in accordance with a protocol associated with a specific port. For example, the protocol may be HTTP, SMTP, DNS, Time, SNTP, IRC or RPC DCOM.

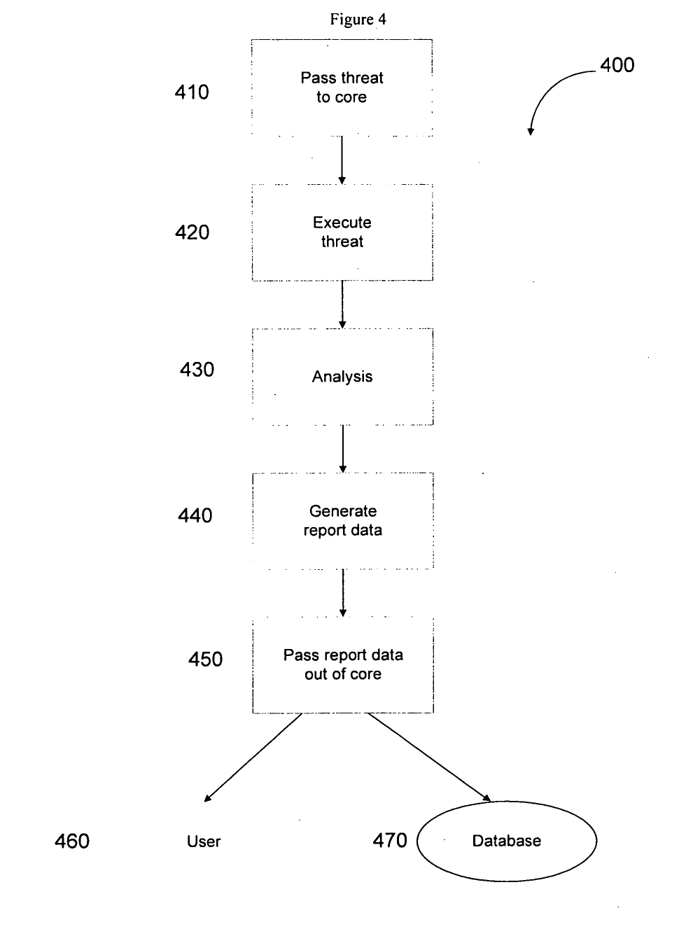

Referring to FIG. 4 there is illustrated a method 400 of providing automated threat analysis by utilising core 305 in an isolated environment. The method can be performed in a processing system, for example processing system 100, and includes the steps of passing the threat to the core at step 410, executing the threat in the core using the operating system at step 420, automatically analysing the threat functionality using core components and/or service components at step 430, generating report data at step 440, and passing the report data out of the core at step 450. The report data may then be provided to a user at step 460 and/or stored in a database at step 470.

### FURTHER EXAMPLE

The following example provides a more detailed description of a particular embodiment. The example is intended to be merely illustrative and not limiting to the scope of the present invention.

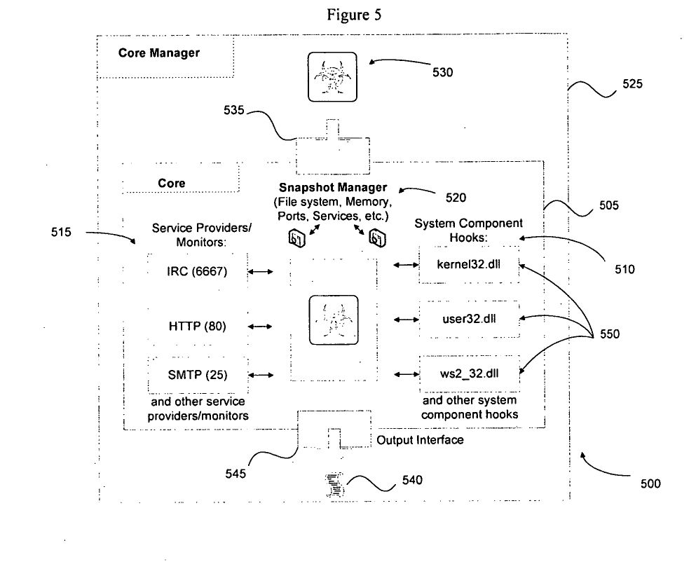

Referring to FIG. 5, there is illustrated a functional block diagram of a further example Automated Threat Analysis System (ATAS). Functionally, ATAS 500 includes the following components:
1. Core 505—a fully isolated physical or virtual environment that involves the following sub-components:
   Tweaked operating system (OS) and hooks 510
   Service providers and monitors 515
   Snapshot Manager 520
2. Core Manager 525
3. Wrapper
4. Database

Core Manager 525 provides the Core 505 component with a threat sample 530 via the Input Interface 535. Core Manager 525 then instructs Core 505 to execute the threat in a fully isolated hardware or hardware-emulated (i.e. virtual) environment. Software that runs inside Core monitors the threat and inspects the threat's behaviour. The collected information can then be placed into the reports 540 which are delivered back to the Core Manager 525 via Output Interface 545. The interfaces are built in such a way that a threat cannot “escape” from the isolated environment. This task is achieved by employing strictly defined internal formats for the reports that are delivered via a file sharing mechanism. There are no network communications used to accomplish this task (in case of the virtual environment, the NAT service is fully disabled).

A Wrapper coordinates work between the Core Manager and the Database components to establish a forensics database update with the newly obtained information.

Modified Operating System (OS) and Hooks

The operating system inside Core 505 is modified in such a way that many of the system libraries 550 are hooked to forward their functionality into the Core's own components. This serves two major purposes:
To log the functions invoked by a threat, including the function parameters;
To modify the returns of the invoked functions

An example implementation of an API hook is as follows: a system DLL's export entry is patched with the export forward. Forwarded export is then handled by the Core's own DLL: it is either served entirely by the DLL, or the call is then forwarded back into the native DLL. In any case, the call handler is capable of modifying parameters and/or logging the function call itself. If a native Windows system DLL performs hash-based checks (such as file contents or export table CRC checks), then the native DLL logics should also be patched so that it allows itself to be loaded in spite of its file being physically modified. Windows file integrity checks should also be disabled in this case to prevent the patched system DLLs from being restored from the Windows DLL cache.

For example, by hooking the Windows system API User32.SetWindowsHookEx( ), it is possible to reveal the following parameters: hook procedure and the handle to the DLL that contains the hook procedure. By knowing the handle to the hook module, it is possible to reveal the filename of the module that was requested as a hook handler. This way, it becomes possible to reveal any attempts to install keystroke monitors that are used by keyloggers. Once logged, the intercepted API call is then forwarded back to the native system DLL to be served in a proper manner.

An example of how the invoked function return may be modified is as follows: the hooks installed on the system APIs RasEnumConnections( ) and RasGetConnectStatus( ) of rasapi32.dll allow Core to fake the presence of a valid RAS connection in the system, should a threat rely on this fact in its logics. Core DLL can return the API call to the caller. That is, the intercepted API call is never forwarded back to the native DLL.

Service Providers & Monitors

Core Manager's service providers 515 can include:
HTTP Server
SMTP Server
DNS Server
Time Server
SNTP Server
IRC Server
RPC DCOM Provider

These servers listen on corresponding ports and serve incoming requests in strict accordance with the relevant protocol specification. For example, RPC DCOM Provider listens on ports 135/445 with the native Windows server switched off (such as LSASS—The Local Security Authority Subsystem Service). As soon as a threat attempts to establish a new connection on ports 135/445, the installed RPC DCOM Provider accepts the connection and provides the connected client with legitimate response SMB packets according to protocol. Accepted SMB packets are then logged and wrapped into the reports that are then delivered back to Core Manager. The “dumped” traffic is then analysed by Core Manager to reveal any attempts by the connected clients to rely on existing RPC DCOM exploits. If there were exploit signatures detected in the intercepted traffic, then the threat that generated such traffic can be identified as a RPC DCOM worm (such as Spybot, Randex, IRC bot, etc.)

Appendix A provides an example report resulting from a Spybot and contains information about an MSO4-12 exploit detected in the outbound traffic on port 135/tcp.

The Time/SNTP Servers can be used to serve any possible threat attempts to rely on a time factor in functionality (such as the Sober worm).

Appendix B provides an example report resulting from the Sober worm and relies on the date Jan. 5, 2006—the last day when the Sober worm still replicated; the next day its mass-mailing routine was stopped.

The HTTP Server monitors any possible HTTP Get/Post requests that a threat may generate.

The DNS Server supplies a client that makes a DNS query with a fake MX record for the recipient's domain name, which is a host name of a mail exchange server accepting incoming mail for that domain. This is required to reveal any mass mailers that rely on DNS servers in their mass mailing functionality (such as Netsky, Sober).

The SMTP Server communicates with the clients acting like a legitimate SMTP Server: a threat is convinced that it communicates with the real SMTP server. The intercepted SMTP traffic is then delivered back to Core Manager for further analysis and parsing.

The IRC Server accepts incoming requests to join IRC channels and generates responses that are common for the legitimate IRC servers. Moreover, IRC server attempts to release hacker commands to the connected client. The commands it sends are common for IRC bots, such as Randex and Spybot. If the connected bot does not rely on password-protected authentication, then the IRC server may cause the connected bot to initiate DoS attacks inside the isolated environment to make sure that the connected bot is capable of initiating such attacks.

Snapshot Manager

Snapshot Manager 520 makes snapshots before and after a threat is run. Snapshot Manager 520 then compares two snapshots and reveals any differences that may have taken place in the system. The snapshots may be taken for the following Windows objects:
File system
Registry
Service Control Manager
Memory (all processes and modules)
Ports
Screen
Kernel components, such as Interrupt Descriptor Table, System Service Descriptor Table, installed kernel device drivers, Model-Specific Registers, Major I/O Request Packet Function Tables in the device driver objects, etc.

If the Snapshot Manager reveals any changes in the file system after running a threat, it is assumed that the file changes were induced by that threat. Any modifications in the state of the kernel components, such as modified contents of the System Service Descriptor Table, or modified addresses of the Major I/O Request Packet Functions, are designed to reveal a possible rootkit component of the threat. The Snapshot Manager contains a large database of exclusions to filter out those changes that are normally caused by the operating system itself.

The file system and registry changes, changes in the services, and open ports are all wrapped into the reports that are delivered to the Core Manager. Memory is handled in the following way: the Snapshot Manager reveals any newly created processes and/or any newly loaded modules. For every newly created process/module, a mapped executable/DLL filename is revealed to check if the retrieved filename is among the newly created files.

This approach reveals only newly created processes/modules that correspond to the newly created files. Then, the Snapshot Manager dumps the new processes/modules and delivers the dumps back into the Core Manager for further analysis. This allows the Core Manager to accomplish heuristics analysis over the memory dumps to detect any additional characteristics, as memory dumps represent memory images of the malicious code in the unpacked/decoded/unencrypted form, the form that the malicious code obtains at some point in order to run. The threat must be capable of decrypting itself in order to run. Once decrypted, the threat is dumped and the dump is studied and searched for signatures.

The Snapshot Manager is also capable of detecting any newly created windows in the system. The Snapshot Manager then snapshots the screen contents, cuts out the background and delivers the image back in the reporting system.

If a threat starts generating SMTP traffic, then the Snapshot Manager loads a Graphics User Interface (GUI) that fakes the look of an email client application. Then, it loads into the GUI all the characteristics of the intercepted SMTP traffic, such as email sender, recipient, subject, message body and attachment name. Once the GUI is populated, a new snapshot image is created and delivered back to the Core Manager. The final report can then create a screen capture designed to simulate how a new mass-mailer would look in an email client application.

In another form, ATAS can be used to provide for the detection of rootkit files/ADS and registry entries. This can be achieved if the second snapshot of an affected systems was taken from a clean primary partition by reading the affected (secondary) partition's files/registry. Automatic partition mounting is achievable both for a physical machine (by using relays) and a virtual machine (by modifying files that represent virtual drives and machine configuration).

Appendices A and B demonstrate many of the aforementioned features. The reports are produced by an example implementation of the Automated Threat Analysis System.

The embodiments discussed may be implemented separately or in any combination as a software package or components. Such software can then be used to notify, restrict, and/or prevent malicious activity being performed. Various embodiments can be implemented for use with the Microsoft Windows operating system or any other operating system.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

### APPENDIX A

### Generated Report for Spybot

Submission Summary:

| | |
|---|---|
| Submission Date: | 31/1/2006 |
| File Size: | 130,048 bytes |
| File MD5: | 0x2EC1FA5FCA52B9C36BDDEA3511178882 |
| Procesing Time: | 1 min 55 sec |
| Submission Options: | Default |
| Behavioural | Registers itself in the registry to start each time |
| Characteristics: | that user starts Windows |
| | Backdoor trojan functionality that gives an |
| | attacker unauthorized access to a compromised |
| | computer |
| | An IRC Bot capable to join IRC networks and |
| | participate in DoS attacks |
| | An RPC DCOM Worm capable to replicate across |
| | networks by utilising existing exploits |
| | A Network-aware worm capable to replicate |
| | across network shares |

Technical Details:

To mark its presence in the system, the sample created the following Mutex object:
aleks001

The following file was created in the system:

| | |
|---|---|
| File MD5: | 0x2EC1FA5FCA52B9C36BDDEA3511178882 |
| File Size: | 130,048 bytes |
| Detection | Backdoor.Win32.Rbot.adf [Kaspersky], W32.Spybot.ZIF |
| | [Symantec], W32/Sdbot.worm.gen.bg [McAfee] |
| Filename: | %System%\svcdata.exe |

Note:
%System% is a variable that refers to the System folder. By default, this is C:\Windows\System (Windows 95/98/Me), C:\Winnt\System32 (Windows NT/2000), or C:\Windows\System32 (Windows XP)

| | |
|---|---|
| Process Name | Proccess Filename |
| svcdata.exe | %System%\svcdata.exe |

Attention! There was outbound traffic produced on port 135/tcp with the following characteristics:

Automated Threat Analysis System has performed Heuristics Analysis of the created process and detected the following:

| Details | Detected in Process |
|---|---|
| Bugtraq ID 9213: DameWare Mini Remote | svcdata.exe |
| Control Server Pre-Authentication Buffer | (%System%\svcdata.exe) |
| Overflow Vulnerability | |
| MS03-026: DCOM RPC Interface Buffer | svcdata.exe |
| Overrun Vulnerability-replication across | (%System%\svcdata.exe) |
| TCP 135/139/445/593 (common for | |
| Spybot, Randex, other IRC Bots) | |
| MS03-007: Microsoft IIS WebDAV Remote | svcdata.exe |
| Compromise Vulnerability-Unchecked | (%System%\svcdata.exe) |
| Buffer In Windows Component Could | |
| Cause Server Compromise | |
| MS04-011: LSASS Overflow exploit- | svcdata.exe |
| replication across TCP 445 (common for | (%System%\svcdata.exe) |
| Sasser, Bobax, Kibuv, Korgo, Gaobot, | |
| Spybot, Randex, other IRC Bots) | |
| Capability to join IRC channels and | svcdata.exe |
| communicate with the remote computers | (%System%\svcdata.exe) |
| (e.g. with the purpose of notification or | |
| remote administration) | |
| Capability to perform DoS attacks against | svcdata.exe |
| other computers | (%System%\svcdata .exe) |

Automated Threat Analysis System has established that the sample is capable to steal CD keys of the following games:
Battlefield 1942
Chrome
FIFA 2002
FIFA 2003
Half-Life
Hidden & Dangerous 2
Nascar Racing 2002
Nascar Racing 2003
Need For Speed Hot Pursuit 2
NHL 2002
NHL 2003
Soldier of Fortune II—Double Helix
The Gladiators
   Automated Threat Analysis System has established that the sample is capable to spread across the following network shares:
ADMIN$
C$
D$
IPC$
   Remote activation is achieved by creating a scheduled task with the NetBEUI function, NetScheduleJobAdd( ). Network propagation across the weekly restricted shares uses the following login credentials dictionary:
007
123
1234
12345
123456
1234567
12345678
123456789
2002
2004
accept
access
accounting
accounts
action
Admin
admin$
Administrador
Administrat
Administrateur
administrator
admins
aliases
america
april
backup
bill
bitch
blank
brian
capture
changeme
Chris
cisco
compaq
computer
connect
continue
control
country
crash
database
databasepass
databasepassword
db1234
dbpass
dbpassword
december
default
Dell
display
domain
domainpass
domainpassword
download
email
england
english
exchange
france
french
friday
george
god
guest
hello
home
homeuser
internet
intranet
ipc$
kate
katie
kermit
linux
login
loginpass
logout
lol
marcy
mary
mike
monday
netbios
netdevil
network
nokia
november
OEM
oeminstall
oemuser
office
oracle
outlook
OWNER
pass
pass1234
passwd
Password
password1
peter
PHP
pwd
qwerty
random
ROOT
running
saturday
serial
SERVER
sex
SHARE
siemens
sql
staff
start
student
sunday
susan
SYSTEM
teacher
technical
TEST
thursday
tuesday
UNIX
unknown
upload
user
username
video
win2000
win2k
win98
windows
winnt
winpass
winxp
wmd
wwwadmin
   The newly created Registry Values are:
svcdata.exe=“svcdata.exe”
   in the registry key
   HKEY_LOCAL_MACHINE\SOFTWARE\Microsoft\Windows\CurrentVersion\Run
   so that svcdata.exe runs every time Windows starts
svcdata.exe=“svcdata.exe”
   in the registry key
   HKEY_LOCAL_MACHINE\SOFTWARE\Microsoft\Windows\CurrentVersion\RunServices
   so that svcdata.exe runs every time Windows starts
svcdata.exe=“svcdata.exe”
   in the registry key
   HKEY_CURRENT_USER\Software\Microsoft\Windows\CurrentVersion\Run
   so that svcdata.exe runs every time Windows starts

The following ports were open in the system:

| Port number | Protocol | Opened by File |
|---|---|---|
| 69 | UDP | %System%\svcdata:exe |
| 113 | TCP | %System%\svcdata.exe |
| 1057 | UDP | %System%\svcdata.exe |
| 1892 | TCP | %System%\svcdata.exe |
| 1893 | TCP | %System%\svcdata.exe |
| 1894 | TCP | %System%\svcdata.exe |
| 1896 | TCP | %System%\svcdata.exe |
| 1897 | TCP | %System%\svcdata.exe |
| 1898 | TCP | %System%\svcdata.exe |
| 1899 | TCP | %System%\svcdata.exe |
| 1900 | TCP | %System%\svcdata.exe |
| 1901 | TCP | %System%\svcdata.exe |
| 1902 | TCP | %System%\svcdata.exe |
| 2001 | TCP | %System%\svcdata.exe |
| 45343 | TCP | %System%\svcdata.exe |

The following Host Name was requested from a host database:
scv.unixirc.de

There registered attempts to establish connection with the remote IP addresses. The connection details are:

| Remote IP address | Port Number |
|---|---|
| 127.0.247.251 | 139 |
| 127.0.194.235 | 139 |
| 127.0.242.158 | 139 |
| 127.0.138.223 | 139 |
| 127.0.241.85 | 139 |
| 127.0.33.8 | 139 |
| 127.0.136.126 | 139 |
| 127.0.44.180 | 135 |
| 127.0.0.36 | 1234 |
| 127.0.165.253 | 135 |
| 127.0.235.240 | 135 |
| 127.0.0.37 | 1234 |
| 127.0.40.2 | 135 |
| 127.0.0.38 | 1234 |
| 127.0.111.206 | 135 |
| 127.0.0.39 | 1234 |
| 127.0.67.89 | 135 |
| 127.0.0.40 | 1234 |
| 127.0.0.41 | 1234 |
| 127.0.0.42 | 1234 |
| 127.0.200.55 | 135 |
| 127.0.0.43 | 1234 |
| 127.0.0.44 | 1234 |
| 127.0.219.45 | 135 |
| 127.0.0.45 | 1234 |
| 127.0.0.46 | 1234 |
| 127.0.0.47 | 1234 |
| 127.0.63.112 | 135 |
| 127.0.0.48 | 1234 |
| 127.0.31.86 | 135 |

Attention! There was a new connection established with a remote IRC Server. The generated outbound IRC traffic is provided below:
NICK USA|20611
USER fzcsf 0 0 :USA|20611
USERHOST USA|20611
MODE USA|20611 -x
JOIN ##asn-new## asns
NOTICE USA|20611 :.VERSION mIRC v6.14 Khaled Mardam-Bey.
PRIVMSG ##asn-new## :[MAIN]: Status: Ready. Bot Uptime: 0d 0h 0m.
PRIVMSG ##asn-new## :[MAIN]: Bot ID: aleks001.
PRIVMSG ##asn-new## :[SCAN]: Exploit Statistics: WebDav: 0, NetBios: 0, NTPass: 0, Dcom135: 0, Dcom2: 0, MSSQL: 0, Beagle1: 0, Beagle2: 0, MyDoom: 0, lsass_{—}445: 0, Optix: 0, UPNP: 0, NetDevil: 0, DameWare: 0, Kuang2: 0, Sub7: 0, WksSvc English: 0, WksSvc Other: 0, Veritas Backup Exec: 0, ASN.1-HTTP:..PRIVMSG ##asn-new## :[MAIN]: Uptime: 0d 0h 3m.
PRIVMSG ##asn-new## :[PROC]: Failed to terminate process: [Antivirus/Firewall]
PRIVMSG ##asn-new## :[HTTPD]: Server listening on IP: 127.0.0.1:2001, Directory: \.
PRIVMSG ##asn-new## :[DDoS]: Flooding: (127.0.0.2:1234) for 50 seconds.
PRIVMSG ##asn-new## :[SYN]: Flooding: (127.0.0.2:1234) for 50 seconds.
PRIVMSG ##asn-new## :[SCAN]: Failed to start scan, port is invalid.
PRIVMSG ##asn-new## :[SCAN]: Random Port Scan started on 127.0.x.x:139 with a delay of 5 seconds for 0 minutes using 10 threads.
PRIVMSG ##asn-new## :[SCAN]: Random Port Scan started on 127.0.x.x:135 with a delay of 5 seconds for 0 minutes using 10 threads.
PRIVMSG ##asn-new## :[SCAN]: Port scan started: 127.0.0.2:1234 with delay: 50 (ms).
PRIVMSG ##asn-new## :[UDP]: Sending 40 packets to: 127.0.0.2. Packet size: 50, Delay: 60 (ms).
PRIVMSG ##asn-new## :[PING]: Sending 40 pings to 127.0.0.2. packet size: 50, timeout: 60 (ms).
PRIVMSG ##asn-new## :[PING]: Finished sending pings to 127.0.0.2.
PRIVMSG ##asn-new## :[UDP]: Finished sending packets to 127.0.0.2.

### APPENDIX B

### Generated Report for Sober

Submission Summary:

| | |
|---|---|
| Submission Date: | 14/1/2005 |
| File Size: | 135,968 bytes |
| File MD5: | 0x 45067D805EEFE98EB89222C345EA0BFE |
| Procesing Time: | 21 sec |
| Submission Options: | Slow Analysis |
| | Use Date: 5/1/2006 |
| Submission GUID: | 6241B636-51CB-4EC2-859A-62E46A58CF86 |

Technical Details:
Possible Country of Origin:
The new window was created, as shown below:

[image]

The following files were created in the system:

File #1:

| | |
|---|---|
| File MD5: | 0x53D2B479E0FCFDB34882F15B8D69B52E |
| File Size: | 135,968 bytes |
| Detection: | Email-Worm.Win32.Sober.t [Kaspersky], |
| | W32.Sober.W@mm [Symantec], W32/Sober.s.dr |
| | [McAfee] |
| Filename: | [sample's original directory]\sample.exe |

File #2:

| | |
|---|---|
| File MD5: | 0x046470C7F32B81A8DAB4B326ABAD3FC4 |
| File Size: | 128,032 bytes |
| Detection: | Email-Worm.Win32.Sober.t [Kaspersky], |
| | W32.Sober.W@mm [Symantec], W32/Sober.s@MM |
| | [McAfee] |
| Filename: | %Windir%\ConnectionStatus\Microsoft\services.exe |

File #3:

| | |
|---|---|
| File MD5: | 0x2EE70864077AEAB4F5272BE40A6121D5 |
| File Size: | 572 bytes |
| Filename: | %Windir%\ConnectionStatus\Microsoft\concon.www * |

File #4:

| | |
|---|---|
| File MD5: | 0xD91BC7EA0FE6FAB8ADDA3C1EA77B96D2 |
| File Size: | 55,390 bytes |
| Detection: | Email-Worm.Win32.Sober.y [Kaspersky], |
| | W32.Sober.X@mm [Symantec], |
| | W32/Sober@MM!M681 [McAfee] |
| Filename: | %Windir%\WinSecurity\services.exe * |

File #5:

| | |
|---|---|
| File MD5: | 0x22586BCA92AFE4DD6DE09B47B5EB6942 |
| File Size: | 55,390 bytes |
| Detection: | Email-Worm.Win32.Sober.y [Kaspersky], |
| | W32.Sober.X@mm [Symantec], |
| | W32/Sober@MM!M681 [McAfee] |
| Filename: | %Windir%\WinSecurity\smss.exe * |

File #6:

| | |
|---|---|
| File MD5: | 0x248639727EBECCFF6208EC8E0C7C3656 |
| File Size: | 55,390 bytes |
| Detection: | Email-Worm.Win32.Sober.y [Kaspersky], |
| | W32.Sober.X@mm [Symantec], |
| | W32/Sober@MM!M681 [McAfee] |
| Filename: | %Windir%\WinSecurity\csrss.exe * |

File #7:

| | |
|---|---|
| File MD5: | 0xAC89003431B8D710EAF8A3EB1C78AFAA |
| File Size: | 75,996 bytes |
| Detection: | Email-Worm.Win32.Sober.y [Kaspersky], |
| | W32.Sober.X@mm [Symantec] |
| Filename: | %Windir%\WinSecurity\socket1.ifo * |
| | %Windir%\WinSecurity\socket2.ifo * |
| | %Windir%\WinSecurity\socket3.ifo * |

File #8:

| | |
|---|---|
| File MD5: | 0x09C5A82D82864767B3D2007A076E8AED |
| File Size: | 323 bytes |
| Filename: | %Windir%\WinSecurity\mssock1.dli * |

File #9:

| | |
|---|---|
| File MD5: | 0x01C36540D2698C656943455D626A64AE |
| File Size: | 316 bytes |
| Filename: | %Windir%\WinSecurity\mssock2.dli * |

File #10:

| | |
|---|---|
| File MD5: | 0x9112928B96323BC8BC55CC5AD1982DEF |
| File Size: | 308 bytes |
| Filename: | %Windir%\WinSecurity\mssock3.dli * |

File #11:

| | |
|---|---|
| File MD5: | 0x67498F5CFC994C30A66BE29C7CEB4D53 |
| File Size: | 526 bytes |
| Filename: | %Windir%\WinSecurity\winmem1.ory * |
| | %Windir%\WinSecurity\winmem2.ory * |
| | %Windir%\WinSecurity\winmem3.ory * |

The following directories were created:
%Windir%\ConnectionStatus
%Windir%\WinSecurity
   Notes:
[sample's original directory]\sample.exe stands for a filename that is used by ThreatForensics to implants the original sample into the system
%Windir% is a variable that refers to the Windows installation folder. By default, this is C:\Windows or C:\Winnt
The specified filename is not constant across the entire report (e.g. not always created or is random)

There were new processes created in the system:

| Process Name | Proccess Filename |
|---|---|
| services.exe | %Windir%\WinSecurity\services.exe |
| smss.exe | %Windir%\WinSecurity\smss.exe |
| csrss.exe | %Windir%\WinSecurity\csrss.exe |
| Sample.exe | [sample's original directory]\sample.exe |
| services.exe | %Windir%\ConnectionStatus\Microsoft\services.exe |

The newly created Registry Values are:
WinCheck=“%Windir%\ConnectionStatus\Microsoft\services.exe”
   in the registry key
   HKEY_LOCAL_MACHINE\SOFTWARE\Microsoft\Windows\CurrentVersion\Run
   so that services.exe runs every time Windows starts
Windows=“%Windir%\WinSecurity\services.exe”
   in the registry key
   HKEY_LOCAL_MACHINE\SOFTWARE\Microsoft\Windows\CurrentVersion\Run
   so that services.exe runs every time Windows starts
_WinCheck=“%Windir%\ConnectionStatus\Microsoft\services.exe”
   in the registry key
   HKEY_CURRENT_USER\Software\Microsoft\Windows\CurrentVersion\Run
   so that services.exe runs every time Windows starts
_Windows=“%Windir%\WinSecurity\services.exe”
   in the registry key
   HKEY_CURRENT_USER\Software\Microsoft\Windows\CurrentVersion\Run
   so that services.exe runs every time Windows starts

The following ports were open in the system:

| Port number | Protocol | Opened by File |
|---|---|---|
| 1362 | TCP | %Windir%\WinSecurity\services.exe |
| 1394 | TCP | %Windir%\WinSecurity\csrss.exe |
| 1395 | TCP | %Windir%\WinSecurity\smss.exe |

The following Host Names were requested from a host database:
cuckoo.nevada.edu
smtp.sbcglobal.yahoo.com
smtp.compuserve.de
mail.postman.net
smtpauth.earthlink.net
relay.clara.net
auth.smtp.kundenserver.de
smtp.isp.netscape.com
smtp.ameritech.yahoo.com
smtp.aol.com
smtp.lund1.de
smtp.mail.ru
ntp-sop.inria.fr
time-ext.missouri.edu
[MX record for the recipient's domain name]
ntp1.theremailer.net
ntp0.cornell.edu
gandalf.theunixman.com
time.xmission.com
redir-mail-telehouse1.gandi.net
utcnist.colorado.edu
tombrider.ealaddin.com
time.ien.it
mxl.icq.mail2world.com
mx-ha01.web.de
mailhost.ip-plus.net
mx0.gmx.net
ntp-1.ece.cmu.edu
relay2.ucia.gov
mx.nyc.untd.com
mx1.F-Secure.com
etrn.nextra.cz
ntp2c.mcc.ac.uk
mx.arcor.de
sitemail2.everyone.net
   Note: there was a DNS query made requesting the MX record for the recipient's domain name, which is a host name of mail exchange server accepting incoming mail for that domain.
   Attention! There was outbound SMTP traffic registered in the system with the following email message characteristics:
   Email Sender (spoofed):
Postman@thawte.com
Postmaster@Ebay.com
Info@verisign.com
Webmaster@thawte.com
steve_johnson@somewhere.com
Service@thawte.com
BKA.Bund@bka.bund.de
Info@netlock.net
Gewinn@RTL.de
BKA@bka.bund.de
BKA@BKA.de
Admin@trustcenter.de
webmaster@verisign.com
Internet@bka.bund.de
Hostmaster@correo.com.uy
Service@digsigtrust.com
postman@nowhere.com
Admin@thawte.com
Hostmaster@Ebay.com
Postmaster@valicert.com
Internet@BKA.de
Department@fbi.gov
Hostmaster@thawte.com
Service@netlock.net
RTL-TV@RTLWorld.de
Admin@cia.gov
Info@digsigtrust.com
RTL@RTLWorld.de
Hostmaster@saunalahti.fi
postmaster@somewhere.com
Postmaster@saunalahti.fi
Postman@feste.org
Webmaster@digsigtrust.com
Info@someplace.com
office@nowhere.com
Service@verisign.com
Hostmaster@feste.org
Postman@ptt-post.nl
Service@mail.ips.es
Downloads@BKA.de
Postmaster@feste.org
hostmaster@e-trust.be
RTL-TV@RTL.de
Info@Ebay.com
info@somewhere.com
ellenorzes@netlock.net
Webmaster@correo.com.uy
Postmaster@thawte.com
BKA.Bund@BKA.de
Admin@correo.com.uy
   Note: sender email address is spoofed—it uses domain part of some locally stored email addresses
   Email Recipient:
mailingbox@yahoo.de
listening@hotmail.de
steve_lynch@gmx.de
steve_lynch@yahoo.de
premium-server@hotmail.de
ips@gmx.at
info@yahoo.com
premium-server@yahoo.de
steve_lynch@gmx.at
ellenorzes@yahoo.com
smntp@yahoo.de
XPost@hotmail.de
steve_lynch@yahoo.com
ThisAccount@yahoo.de
x_mail-list@gmx.at
feste@yahoo.de
cps@hotmail.de
mailserver9618@yahoo.com
MailIn_Box@hotmail.de
x_mail-list@gmx.de
ips@hotmail.de
feste@yahoo.com
zfreemailer@yahoo.de
silver-certs@hotmail.de
personal-freemail@gmx.de
Z-User@gmx.at
XFreeMail@yahoo.com
Z-User5719@gmx.at
steve_johnson@gmx.at
email@yahoo.com
ThisAccount@thawte.com
steve_lynch@gmx.ch
ThisAccount@hotmail.de
Z-User@gmx.net
steve_lynch@hotmail.com
zfreemailer@thawte.com
steve_lynch@gmx.net
   Email Subject:
Mailzustellung wurde unterbrochen
Sehr geehrter Ebay-Kunde
SMTP Mail gescheitert
hi,_ive_a_new_mail_address
Mailzustellung_wurde_unterbrochen
Sie besitzen Raubkopien
RTL: Wer wird Millionaer
Mail delivery failed
Ihr Passwort
Your Password
Ermittlungsverfahren wurde eingeleitet
Paris Hilton & Nicole Richie
Account Information
Account_Information
Sie_besitzen_Raubkopien
You visit illegal websites
RTL:_Wer_wird_Millionaer
smtp mail failed
Ihr_Passwort
smtp_mail_failed
Registration Confirmation
Your_Password
Paris_Hilton_&_Nicole_Richie
Sehr_geehrter_Ebay-Kunde
Your IP was logged
   Attachment Name:
Email_text.zip
Ebay-User11788_RegC.zip
Email.zip
mailtext.zip
Akte2569.zip
Gewinn_Text.zip
mail.zip
thawte-TextInfo.zip
Akte5490.zip
Akte9374.zip
reg_pass.zip
Akte2129.zip
downloadm.zip
Ebay-User16494_RegC.zip
valicert-TextInfo.zip
Akte6002.zip
question_list.zip
Akte4824.zip
netlock-TextInfo.zip
RTL-TV.zip
Gewinn.zip
RTL.zip
mail_body.zip
verisign-TextInfo.zip
mail-TextInfo.zip
Akte9704.zip
feste-TextInfo.zip
Ebay.zip
Akte5015.zip
Akte1594.zip
reg_pass-data.zip
trustcenter-TextInfo.zip
Akte9549.zip
nowhere-TextInfo.zip
question_list558.zip
Akte6272.zip
Ebay-User15216_RegC.zip
list.zip
digsigtrust-TextInfo.zip
e-trust-TextInfo.zip
Akte6818.zip
WWM_Text.zip
Akte1368.zip
somewhere-TextInfo.zip
WWM.zip

Message Body:

This is an automatically generated Delivery Status
Notification. SMTP_Error [ ] I'm afraid I wasn't able to
deliver your message. This is a permanent error; I've given
up. Sorry it didn't work out. The full mail-text and header
is attached!
Bei uns wurde ein neues Benutzerkonto mit dem Namen
“HandgranatenHarald1963” beantragt. Um das Konto
einzurichten, benoetigen wir eine Bestaetigung, dass die
bei der Anmeldung angegebene e-Mail-Adresse stimmt. Bitte
senden Sie zur Bestaetigung den ausgefuellten Anhang an
uns zurueck. Wir richten Ihr Benutzerkonto gleich nach
Einlangen der Bestaetigung ein und verstaendigen Sie dann
per e-Mail, sobald Sie Ihr Konto benutzen koennen. Vielen
Dank, Ihr Ebay-Team
hey its me, my old address dont work at time. i dont know
why?! in the last days ive got some mails. i' think thaz
your mails but im not sure! plz read and check . . . cyaaaaaaa
Sehr geehrte Dame, sehr geehrter Herr, das Herunterladen
von Filmen, Software und MP3s ist illegal und somit
strafbar. Wir moechten Ihnen hiermit vorab mitteilen, dass
Ihr Rechner unter der IP 134.109.110.222 erfasst wurde.
Der Inhalt Ihres Rechner wurde als Beweismittel
sichergestellt und es wird ein Ermittlungsverfahren gegen
Sie eingleitet. Die Strafanzeige und die Moeglichkeit zur
Stellungnahme wird Ihnen in den naechsten Tagen
schriftlich zugestellt. Aktenzeichen NR.: #2569 (siehe
Anhang) Hochachtungsvolli.A.
Juergen Stock---Bundeskriminalamt BKA---Referat LS 2---
65173 Wiesbaden---Tel.: +49 (0)611-55-12331 oder---
Tel.: +49 (0)611-55-0
Glueckwunsch: Bei unserer EMail Auslosung hatten Sie und
weitere neun Kandidaten Glueck. Sie sitzen demnaechst bei
Guenther Jauch im Studio!Weitere Details ihrer Daten
entnehmen Sie bitte dem Anhang.+++ RTL interactive GmbH+++
Geschaeftsfuehrung:
Dr. Constantin Lange+++Am Coloneum 1+++ 50829 Koeln+++
Fon: +49(0) 221-780 0 oder+++ Fon: +49 (0) 180 5 44 66 99
Ihre Nutzungsdaten wurden erfolgreich geaendert. Details
entnehmen Sie bitte dem Anhang.***
http://www.thawte.com*** E-Mail:
PassAdmin@thawte.com
Sehr geehrte Dame, sehr geehrter Herr, das Herunterladen
von Filmen, Software und MP3s ist illegal und somit
strafbar. Wir moechten Ihnen hiermit vorab mitteilen, dass
Ihr Rechner unter der IP 234.153.126.195 erfasst wurde.
Der Inhalt Ihres Rechner wurde als Beweismittel
sichergestellt und es wird ein Ermittlungsverfahren gegen
Sie eingleitet. Die Strafanzeige und die Moeglichkeit zur
Stellungnahme wird Ihnen in den naechsten Tagen
schriftlich zugestellt. Aktenzeichen HR.: #2129 (siehe
Anhang) Hochachtungsvolli.A.
Juergen Stock---Bundeskriminalamt BKA---Referat LS 2---
65173 Wiesbaden---Tel.: +49 (0)611-55-12331 oder---
Tel.: +49 (0)611-55-0
This_is_an_automatically_generated_Delivery_Status_{—}
Notification.SMTP_Error_[ ]
I'm_afraid_I_wasn't_able_to_deliver_your_message. This_is_a_{—}
permanent_error;_I've_given_up. _Sorry_it_didn't_work_out.
The_full_mailtext_and_header_is_attached!
The Simple Life: View Paris Hilton & Nicole Richie video
clips, pictures & more;) Download is free until January,
2006! Please use our Download manager.
Bei uns wurde ein neues Benutzerkonto mit dem Namen
“Pippi” beantragt. Um das Konto einzurichten, benoetigen
wir eine Bestaetigung, dass die bei der Anmeldung
angegebene e-Mail-Adresse stimmt. Bitte senden Sie zur
Bestaetigung den ausgefuellten Anhang an uns zurueck. Wir
richten Ihr Benutzerkonto gleich nach Einlangen der
Bestaetigung ein und verstaendigen Sie dann per e-Mail,
sobald Sie Ihr Konto benutzen koennen. Vielen Dank, Ihr
Ebay-Team
Ihre Nutzungsdaten wurden erfolgreich geaendert. Details
entnehmen Sie bitte dem Anhang.***
http://www.valicert.corn*** E-Mail: PassAdmin@valicert.com
Sehr geehrte Dame, sehr geehrter Herr, das Herunterladen
von Filmen, Software und MP3s ist illegal und somit
strafbar. Wir moechten Ihnen hiermit vorab mitteilen, dass
Ihr Rechner unter der IP 105.115.122.173 erfasst wurde.
Der Inhalt Ihres Rechner wurde als Beweismittel
sichergestellt und es wird ein Ermittlungsverfahren gegen
Sie eingleitet. Die Strafanzeige und die Moeglichkeit zur
Stellungnahme wird Ihnen in den naechsten Tagen
schriftlich zugestellt. Aktenzeichen NR.: #4824 (siehe
Anhang) Hochachtungsvolli.A.
Juergen Stock---Bundeskriminalamt BKA---Referat LS 2---
65173 Wiesbaden---Tel.: +49 (0)611-55-12331 oder---
Tel.: +49 (0)611-55-0
Dear Sir/Madam, we have logged your IP-address on more than
30 illegal Websites. Important:Please answer our
questions! The list of questions are attached. Yours
faithfully, Steven Allison++++ Central Intelligence Agency-
CIA-++++ Office of Public Affairs++++
Washington, D.C. 20505++++ phone: (703) 482-0623++++ 7:00
a.m. to 5:00 p.m., US Eastern time
Ihre Nutzungsdaten wurden erfolgreich geaendert. Details
entnehmen Sie bitte dem Anhang.*** http://www.feste.org***
E-Mail: PassAdmin@feste.org
Bei uns wurde ein neues Benutzerkonto mit dem Namen
“HandgranatenHarald” beantragt. Um das Konto einzurichten,
benoetigen wir eine Bestaetigung, dass die bei der
Anmeldung angegebene e-Mail-Adresse stimmt.Bitte senden
Sie zur Bestaetigung den ausgefuellten Anhang an uns
zurueck. Wir richten Ihr Benutzerkonto gleich nach
Einlangen der Bestaetigung ein und verstaendigen Sie dann
per e-Mail, sobald Sie Ihr Konto benutzen koennen. Vielen
Dank, Ihr Ebay-Team
Sehr geehrte Dame, sehr geehrter Herr, das Herunterladen
von Filmen, Software und MP3s ist illegal und somit
strafbar. Wir moechten Ihnen hiermit vorab mitteilen, dass
Ihr Rechner unter der IP 149.124.75.109 erfasst wurde. Der
Inhalt Ihres Rechner wurde als Beweismittel sichergestellt
und es wird ein Ermittlungsverfahren gegen Sie
eingleitet. Die Strafanzeige und die Moeglichkeit zur
Stellungnahme wird Ihnen in den naechsten Tagen
schriftlich zugestellt. Aktenzeichen NR.: #5015 (siehe
Anhang) Hochachtungsvolli.A.
Juergen Stock---Bundeskriminalamt BKA---Referat LS 2---
65173 Wiesbaden---Tel.: +49 (0)611-55-12331 oder---
Tel.: +49 (0)611-55-0
Account and Password Information are attached!
Ihre Nutzungsdaten wurden erfoigreich geaendert. Details
entnehmen Sie bitte dem Anhang.***
http://www.trustcenter.de*** E-Mail:
PassAdmin@trustcenter.de
Protected message is attached!***** Go to:
http://www.correo.com.uy***** Email: postman@correo.com.uy

1. An automated threat analysis system comprising a core in an isolated environment, the core associated with an input interface and an output interface and the core comprising:
(a) one or more core components; and,
(b) an operating system having at least one library hooked to at least one of the one or more core components;
wherein, when a threat is passed into the core via the input interface and the threat is executed in the core and using the operating system, report data is generated by the one or more core components and the report data is passed out of the core via the output interface.

2. The system as claimed in claim 1, including a snapshot manager to record the state of at least part of the core before and after execution of the threat.

3. The system as claimed in claim 2, wherein at least some of any differences in the state before execution of the threat and the state after execution of the threat form part of the report data.

4. The system as claimed in claim 2, wherein the snapshot manager records the state of one or more of the operating system components of: File system; Registry; Service Control Manager; Memory; Ports; Screen; and Kernel components.

5. The system as claimed in claim 2, wherein the snapshot manager includes a database of exclusions used to filter out normal changes caused by the operating system.

6. The system as claimed in claim 1, wherein the system includes at least one service component that monitors at least one port.

7. The system as claimed in claim 1, wherein the system includes at least one service component that emulates a service provider by exchanging data with the threat in accordance with a protocol of the service provider.

8. The system as claimed in claim 6, wherein the one or more core components record at least part of any data transferred via the at least one port.

9. The system as claimed in claim 8, wherein the recorded data forms part of the report data.

10. The system as claimed in claim 6, wherein the at least one service component is selected from the group of a: HTTP server; SMTP server; DNS server; Time server; SNTP server; IRC server; and RPC DCOM provider.

11. The system as claimed in claim 1, wherein the system includes a core manager that supplies the threat to the core and receives the report data from the core.

12. The system as claimed in claim 1, wherein the system is associated with a searchable database to store the report data from various threats.

13. The system as claimed in claim 12, wherein the system includes a wrapper being an interface between the core manager and the database.

14. The system as claimed in claim 1, wherein the isolated environment is hardware or hardware-emulated.

15. The system as claimed in claim 1, wherein the report data is passed out of the core via the output interface according to a predefined format.

16. A computer program product for providing automated threat analysis, the computer program product comprising a core in an isolated environment, the core associated with an input interface and an output interface and the core comprising:
(a) one or more core components; and,
(b) an operating system having at least one library hooked to at least one of the one or more core components;
wherein, the computer program product is configured such that when a threat is passed into the core via the input interface and the threat is executed in the core and using the operating system, report data is generated by the one or more core components and the report data is passed out of the core via the output interface.

17. The computer program product as claimed in claim 16, wherein the report data forms part of a threat removal tool.

18. The computer program product as claimed in claim 16, wherein the operating system is a modified Windows® operating system.

19. The computer program product as claimed in claim 16, wherein the core is in an isolated hardware or hardware-emulated environment.

20. The computer program product as claimed in claim 16, wherein operating system functions and parameters used by the threat are logged by the one or more core components.

21. The computer program product as claimed in claim 20, wherein at least some return data from the operating system functions are modified by the one or more core components.

22. The computer program product as claimed in claim 16, wherein a core manager controls return data on ports to the core.

23. The computer program product as claimed in claim 22, wherein the return data is provided in accordance with a protocol associated with a port.

24. The computer program product as claimed in claim 23, wherein the protocol is at least one of the group: HTTP; SMTP; DNS; Time; SNTP; IRC; and RPC DCOM.

25. The computer program product as claimed in claim 16, wherein the core includes a snapshot manager to record the state of at least part of the core before and after execution of the threat.

26. The computer program product as claimed in claim 25, wherein the snapshot manager includes, in the report data, at least some of the changes relating to one or more of: the file system; the registry; the memory; new windows; and the use of ports.

27. The computer program product as claimed in claim 16, wherein the report data is passed out of the core via the output interface according to a predefined format

28. A method of providing automated threat analysis by utilising a core in an isolated environment, the core associated with an input interface and an output interface, the core comprising one or more core components and an operating system having at least one library hooked to at least one of the one or more core components, the method comprising the steps of, in a processing system:
(a) passing a threat into the core via the input interface;
(b) executing the threat in the core using the operating system;
(c) generating report data using the one or more core components; and,
(d) passing the report data out of the core via the output interface.
